(19) United States
(12) Patent Application Publication
(10) Pub. No.: US 2004/0162835 A1
(43) Pub. Date: Aug. 19, 2004

(54) System and method for generating patient-specific prescription drug safety instructions

(76) Inventor: Ahmed Ghouri, San Diego, CA (US)

Correspondence Address: John W. Eldredge, Myers Dawes Andras & Sherman LLP, 19900 MacArthur Blvd., Suite 1150, Irvine, CA, 92612, US

(21) Appl. No.: 10/456,347

(22) Filed: Jun. 6, 2003

Related U.S. Application Data
(63) Continuation-in-part of application No. 10/351,083, filed on Jan. 23, 2003.
(63) Continuation-in-part of application No. 10/350,483, filed on Jan. 23, 2003.
(60) Provisional application No. 60/388,444, filed on Jun. 12, 2002.

(51) Int. Cl. G06F 7/00

(52) U.S. Cl. 707/100

(57) ABSTRACT

A particular system and methodology by which patient-specific medication safety instructions and information is defined for any particular patient in a manner that takes not only a drug's identification, dose, and dose frequency into account, but also an entire spectrum of relevant clinical dimensions so as minimize the possibility of harmful interactions while simultaneously maximizing interaction information content. Patient-specific medication safety instructions and information are generated by an automated system that populates a template with data relevant to the patient. The template is populated by substituting layperson-intelligible terminology for symbolic logic argument elements in suitable text strings. Symbolic logic argument elements are derived from a computerized dimensional indexing system implementing multiple databases and performing therapeutic determinations by symbolic structural reasoning with respect to database elemental indices defining the symbolic logic argument elements.

### CROSS REFERENCE TO RELATED APPLICATION

The present application is a continuation-in-part to U.S. patent applications Ser. Nos. 10/351,083 and 10/350,483, both filed Jan. 23, 2003 and entitled COMPUTERIZED SYSTEM AND METHOD FOR RAPID DATA ENTRY OF PAST MEDICAL DIAGNOSES and SYSTEM AND METHOD FOR PATIENT-SPECIFIC OPTIMIZATION OF MEDICAL THERAPY BY SIMULTANEOUS SYMBOLIC REASONING IN ALL CLINICAL DIMENSIONS, respectively. The present application is also related to copending U.S. patent applications entitled SYSTEM AND METHOD FOR MULTI-DIMENSIONAL PHYSICIAN-SPECIFIC DATA MINING FOR PHARMACEUTICAL SALES AND MARKETING and SYSTEM AND METHOD FOR CREATING AND MAINTAINING AN INTERNET-BASED, UNIVERSALLY ACCESSIBLE AND ANONYMOUS PATIENT MEDICAL HOME PAGE, both filed on instant date herewith. All the noted applications are commonly owned with the present application, the entire contents of all of which are expressly incorporated herein by reference.

### FIELD OF THE INVENTION

The present invention relates to systems and methods for generating rapidly and algorithmically patient-specific safety information for prescription medications.

### BACKGROUND OF THE INVENTION

Approximately $100 billion is spent per year on prescription medications in the U.S. alone. Patient compliance with prescription requirements is also a significant problem for a multitude or reasons, including the fact that today's elderly patients (who consume the majority of healthcare expenses) take multiple medications and have difficulty in keeping track of them, especially when newer ones are added or substituted. Furthermore the number of interactions between medications increases exponentially as each new medicine is added, and it becomes very difficult for both MDs and patients to accurately determine whether a side effect is caused by an interacting substance and, if so, which interacting substance or substances.

For example, Drug A may be a drug of choice for treatment of a certain disease, yet it causes adverse side effect reactions when combined with another Drug B. However, there may be a suitable substitute for Drug B that reduces the severity of interaction reactions and may alleviate them altogether. Were this fact known, a pharmacotheraph regime could be devised that would allow for Drug A to be continued. In practice, Drug A may be started, found to have an intolerable side effect due to interaction with Drug B, and discontinued, when it would have been far more beneficial to provide a suitable substitute for the offending Drug B instead, and maintain use of Drug A. Intelligent analyses of drug-drug interactions provides for a more efficacious pharmacotherapy regime, as well as a more rigorous patient safety program.

Importantly, today's prescription drug information provided to patients, most typically by pharmacists at the time of dispensing, is generic in nature. Most often, the nature of such prescription drug information is based on the drug's package labeling and includes all of the indications for which the drug is effective, all contraindications, all observed interactions and other information required by law or regulatory agencies. This information is highly formal in content and is usually characterized by medical terminology and extremely small print.

Although patient information may be converted into layperson-intelligible terminology, the material given to each patient is static, unchanging, and therefore frequently ignored because too many facts are presented, and often presented out of context. For example, substantial space may be allocated to discussion of side effects of a medication related to pregnancy or breastfeeding, yet the patient may be male. Thus, there is a need for both physician and patient to be able to rapidly determine which side effects or interactions are likely in the case of the specific patient for whom the prescription is being prepared, and to be able to further present this information in a manner which is personalized to the patient, and hence not ignored as generic content.

Such information should be relevant not only with respect to the patient's chief complaint (the disease or condition at issue), but also relevant to the patient's pre-existing medical/surgical conditions, drug therapies, and demographic status. Ideally, the information should be branded and dispensed to the patient by his/her own physician, which further enhances its impact in terms of it being read, absorbed, and understood by the patient. The difficulty lies in developing this information in a realistic time frame.

With an ever growing number of pharmaceuticals products becoming available, so too is there an ever increasing amount of information associated with each of these pharmaceuticals products. Physicians are becoming overwhelmed with information of the type that is often critical for appropriate patient care. Examples of such information forms include consensus guidelines for patients with particular diseases, guidelines for specific medications and diagnostic screening guidelines for particular diseases and demographics. Other informational-type examples include clinical data on possible interactions between particular drugs, interactions between drugs and particular diseases, cross-allergies between drugs, and a voluminous set of diagnostic possibilities (often described as differential diagnoses) which need to be considered when a patient is associated with a lab test abnormality, physical finding, or particular complaint. Lack of mastery of these types of information, at the point of care, can lead to lethal or irreversible negative consequences to patient health or recovery prognosis.

Contemporary physicians are often presented with a choice between two less than optimal options; firstly, to attempt to memorize sufficient amounts of this type of information or, secondly, by referring to technical references (paper or electronic) as the need arises. These options are less than optimal in that memorization of all required information to practice state-of-the-art healthcare is formidable, if not impossible, for an ordinary human being. Further, exhaustive reference searches for specifically-needed information is not practical, given the average amount of time a physician is able to expend on any one particular patient. With regard to informational reference searches, the information must be actively sought after and is not generally found in any one particular reference set. References might include medical textbooks, journal articles, and other scientific publications, but might also include bulletins and notices periodically published by the various pharmaceuticals companies themselves, the U.S. Food and Drug Administration, insurance companies, and other similar entities. The physician must not only know what to look for, but also know where to look.

The above noted deficiencies in clinical information acquisition and publication is particularly troublesome in the development of appropriate drug therapy information bulletins. Developing an appropriate drug therapy information sheet or paper, following any diagnosis, is an extremely complicated task and requires a physician to simultaneously consider the interaction characteristics of a large number of relevant clinical factors (termed herein as patient dimensions).

For example, drug X and drug Y, when used together, can cause undesirable side effects. However, drug X may have no interaction with drug Y, but drug X might cause serious harm if a patient has a co-existing disease Z. For example, the heartburn drug Propulsid™ was withdrawn from the market because it was found to be potentially fatal when used in patients with a heart rhythm abnormality known as prolonged QT Syndrome. Importantly, interaction checking alone is not sufficient decision support for today's modern physician, because from the doctor's perspective, interaction warnings represent only potential problems, not potential solutions.

Further, interaction checking should be supplemented by drug-metabolism impairment analysis, exemplified by metabolism impairment due to liver or kidney disease, the organs which eliminate drugs from the body. In patients with advanced age, or with reduced liver or kidney function, many drugs are metabolized by the body at a reduced rate. Accordingly, with impaired kidney or liver function, or extremes of age, drug doses need to be frequently reduced in order to avoid over-dosing. Dosage adjustments, necessary if the drug is to be metabolized by either organ, is determined according to well-defined tables which correlate the dose adjustment against common indices of degree of liver or kidney impairment.

There are a number of possible adverse interactions involving drugs which do not relate to specific metabolism dysfunctions or relate to metabolism impairment of which kidney disease, liver disease, or advanced age, are only a minute subset. For example, certain drugs require dose adjustment when other drugs are concurrently taken, when patients are smokers, or when certain laboratory test abnormalities are noted. In addition, some drugs can be dangerous during pregnancy or breastfeeding (conditions and not diseases or dysfunction), while quite safe otherwise. Also, certain drugs can be dangerous in the context of disease which is completely unrelated to the metabolism of that drug. For example, patients with marked thrombocytopenia (a decreased number of platelets, which are responsible for the clotting of blood) should never receive the blood thinner medication called Coumarin, as the resulting combination can cause spontaneous bleeding into the brain, often resulting in stroke. In this particular scenario, the clinical condition of thrombocytopenia is completely unrelated to the metabolism of Coumarin by the liver, kidney, or age-related factors.

Accordingly, it will be seen as necessary that any patient-specific drug safety information bulletin must contain information that is relevant to the specific patient across all of the relevant clinical dimensions impinging on the drug therapy regimen, and the aggregate of these relevant clinical dimensions must be accommodated simultaneously. To do so requires a unified data model of the patient in which all possible states of each particular dimension are defined symbolically and numerically (mathematically) ordered. A unified patient data model would then allow for machine-based symbolic reasoning and automatic calculation of the most appropriate choices for drug therapy, including necessary dosage adjustments for each chosen drug, and be able to automatically generate appropriate safety, dosage, side-effect and warning information.

The information should be organized in a reader-friendly manner, such that information bulletins on different medications retain a consistent format and context. Finally, the information should be easily retrievable, review able and printable by a simple, inexpensive data terminal device, such as a personal computer of the type resident in most, if not all, doctor's offices.

### SUMMARY OF THE INVENTION

A particular system and methodology by which patient-specific medication safety instructions and information is defined for any particular patient in a manner that takes not only a drug's identification, dose, and dose frequency into account, but also an entire spectrum of relevant clinical dimensions so as minimize the possibility of harmful interactions while simultaneously maximizing interaction information content. Patient-specific medication safety instructions and information are generated by an automated system that populates a template with data relevant to the patient. The template is populated by substituting layperson-intelligible terminology for symbolic logic argument elements in suitable text strings. Symbolic logic argument elements are derived from a computerized dimensional indexing system implementing multiple databases and performing therapeutic determinations by symbolic structural reasoning with respect to database elemental indices defining the symbolic logic argument elements.

In one aspect, the invention is directed to an electronic medical records acquisition, retention and analysis program, that includes a method for generating patient-specific drug safety instructions and information, in which a database is accessed for a medical record specific to the patient, the record including elements defining the patient's pre-existing medications, diseases, allergies, conditions and demographic status. As a newly prescribed medication is input, the newly prescribed medication is evaluated against the patient's database elements and interactions between the newly prescribed medication and the patient's pre-existing medications, diseases, allergies, conditions and demographic status are identified. Patient-specific medication safety instructions literature, including the identified interactions are automatically generated on the basis of the evaluation.

A particular feature of the invention includes a database of medical knowledge elements, the medical knowledge elements comprising a multiplicity of indications, the indications describing a medical or physiological condition in accordance with a standardized usage, a multiplicity of normalized medication indices, each index linked to selected ones of the multiplicity of indications, and a rule set including definition of interactions between other medical knowledge elements in symbolic logic terms.

In another aspect of the invention, the patient-specific medication safety instructions are generated in accordance with a template, the template including a data portion which is automatically populated with the interactions specific to the particular patient. The template also includes a second data portion which is automatically populated with descriptive text relating to the newly prescribed medication. A multiplicity of textual strings is defined, with the strings including logical arguments disposed along the string. Each logical argument is associated to a database element and the database element is substituted for the corresponding logical argument in the textual string. While logical arguments are standardized, database elements to which they are associated contain different values for respective ones of different patients. Thus, each populated template is unique and specific to a particular patient. A further feature of the invention is the information presented by the text strings. The respective text strings of the second data portion include logical arguments pointing to at least one database element selected from the group consisting of a prescription date, a medication name, a medication dose, a dose frequency, and a length of therapy. The respective text strings of the first data portion include logical arguments pointing to at least one database element selected from the group consisting of medication-coexisting medication interactions, medication-coexisting disease interactions, medication-coexisting allergy interactions, contraindications, and precautions.

In a further aspect of the invention, a system for generating a patient-specific drug safety and information bulletin comprises an electronic data input and processing device including at least a display and an input. A medical record, specific to a particular patient, includes at least a record of the patient's present medications. A database, accessible by the electronic data input and processing device, includes database elements comprising a multiplicity of indications, the indications describing a medical or physiological condition in accordance with a standardized usage, a multiplicity of normalized medication indices, each index linked to selected ones of the multiplicity of indications, and a rule set which includes definition of medication interactions expressed in symbolic logic.

An analysis application, hosted on the electronic data input and processing device, automatically identifies particular ones of the interactions upon identification of a particular patient's medical record and input of a newly prescribed medication to the electronic data input and processing device. A drug safety and information bulletin template includes a first data portion which is automatically populated with the particular ones of the identified interactions specific to the particular patient. The template further includes a second data portion which is automatically populated with descriptive text relating to identification and dosage of the newly prescribed medication.

### DESCRIPTION OF THE DRAWINGS

These and other features, aspects and advantages of the present invention will be more completely understood when considered in connection with the following specification, appended claims and accompanying drawings, wherein:

FIG. 1 is a simplified graphical representation of a set of relevant clinical dimensions and associated qualification strings useful in developing a patient-specific prescription drug safety instruction and information bulletin in accordance with the present invention;

FIG. 2 is a simplified, semi-schematic illustration of an exemplary extraction of a specific diagnosis from a normalized medication entry, in accordance with practice of the present invention;

FIG. 3 is an exemplary database relation diagram depicting mapping between a medication tradename, medication manufacturer and medication generic or chemical name;

FIG. 4 is a simplified, semi-schematic illustration of a medical record, including past medical and surgical history, medication, indication and allergy clinical dimension indices, in accordance with practice of the present invention;

FIG. 5 is an exemplary structural diagram of a sample patient-specific prescription drug safety instruction and information bulletin template, indicating structural areas to be populated in accordance with the invention;

FIG. 6 is an exemplary structural diagram of the sample patient-specific prescription drug safety instruction and information bulletin template of FIG. 4 populated with patient-specific substituted text strings, in accordance with the invention.

### DESCRIPTION OF THE INVENTION

The following includes a discussion of “clinical dimensions” in the context of a decision support system utilizing “symbolic reasoning”. These elements are more completely described in co-pending U.S. patent applications Ser. Nos. 10/350,483 and 10/351,083, entitled SYSTEM AND METHOD FOR PATIENT-SPECIFIC OPTIMIZATION OF MEDICAL THERAPY BY SIMULTANEOUS SYMBOLIC REASONING IN ALL CLINICAL DIMENSIONS, and COMPUTERIZED SYSTEM AND METHOD FOR RAPID DATA ENTRY OF PAST MEDICAL DIAGNOSES, respectively, both commonly owned with the present application, the entire contents of which are expressly incorporated herein by reference.

In general terms, the present invention relates to a system and methodology by which patient-specific prescription drug safety information is determined and generated by taking all of the clinical dimensions, relating to that patient, into account when developing a drug therapy regimen. Prescription drug safety information is generated by an electronic system which calls upon database-generated elements to provide relevant information to the patient in a personalized manner.

Suitable patient-specific prescription drug safety information includes administrative elements, such as the date the prescription was written, the prescribing physician's name, office logo if applicable, and emergency contact information. A relevant information sheet also includes the name of the drug (as both a Tradename, if relevant, and a generic name) the drug dose, dose frequency, and length of therapy. A photographic picture of pharmaceutical prescribed is desirable in situations where the drug and dose may be easily identified by shape, color, size or a combination of these features.

In accordance with the invention, patient-specific prescription drug safety information includes clinically relevant informational elements that are generated on the basis of an individual patient's personal clinical dimensions, in a manner to be described below. These clinically relevant informational elements might be characterized as “reasoning-based effects” of the drug at issue, and include the specific timing of medication use in relation to medicines already being taken, drug-coexisting drug interactions (sorted by either severity or frequency), drug-coexisting disease interactions (sorted by severity or frequency), and drug-coexisting allergy interactions, based on known patient's allergies. Other relevant informational elements include patient-specific precautionary alerts, such as when to stop or not stop using the medication, or any other coexisting medication, due to an interaction, and hierarchical side effect profiles, in which the most important in terms of severity (or the most frequent) side effects are listed in the order of their probability of occurring.

Information is generated by evaluating known patient parameters, such as age, sex, weight, ethnicity, medications, lab test findings, diseases, allergies, past surgical history, and the like, and determining which interactions are possible, along with their associated severity and frequency. A scoring system prioritizes multi-dimensional interactions based on clinical relevance and the “reason-based results” are converted to layperson-intelligible text strings. The text strings are printed in accord with a visual template that allows for graphical expression as well as text.

Clinical dimensions are defined by vectorized indices and therapy is optimized by performing simultaneous symbolic reasoning across all clinical dimension vectors. In terms of a clinical reality, a physician evaluates a finite, well-defined set of input variables, the arguments of which are determined during a patient interview and history analysis, in order to inform the system with regard to that particular patient. In accordance with the present invention, these input variables are associated to the clinical dimensions which optimize a particular drug therapy regimen. Necessarily, the clinical dimension vectors are interrelated, with one ore more dimension having a particular, characterized effect on one or more of the other dimensions. Each dimension has a corresponding set of rules by which they are interrelated to the other dimensions.

For example, a co-existing disease, like a heart murmur, can preclude the use of a given drug (e.g., an allergy medicine) entirely due to a life-threatening drug-disease interaction. Similarly, a genetic condition, such as the presence of the BRCAI gene in one's DNA, may preclude the use of estrogen for hormone replacement. Additionally, a low serum sodium condition can make some medications dangerous; certain dosages of certain drugs may need to be adjusted in smokers, even if they do not have any diseases caused by smoking. Without a unified data model which also uses symbolic representations of knowledge, as described herein, all important inter-relationships cannot be simultaneously considered. Summarized, there are several specific clinical dimensions which are often used simultaneously by physicians in order to determine a drug therapy regimen. Each of these clinical dimensions dramatically influences a physician's decision on which medications are to be considered when treating a patient and what dosages should be employed.

In the context of the invention, there are twelve specific clinical dimensions which are simultaneously analyzed in accordance with symbolic reasoning in order to optimize a drug therapy regimen and which develop the clinically relevant information that is used to populate a patient-specific prescription drug safety information bulletin. Although not all twelve dimensions have the same importance in the context of the present invention, they are discussed here for purposes of completeness. The twelve dimensions (which might also be considered as input variables) are exemplified by the following:

Chief Complaint (CC),

History of Present Illness (HPI),

Past Medical History (PMEDHX),

Past Surgical History (PSURGHX),

Family History (FAMHX),

Social History (SOCHX),

Medications (MEDS),

Allergies (ALLER),

Review of Systems (ROS),

Vital Signs (VS),

Physical Exam (PE), and

Diagnostic Tests (LAB).

The Chief Complaint (CC) dimension corresponds generally to a subjective symptom reported by a patient or physical finding made by a physician. Examples of Chief Complaint dimensions might include chest pain, nausea, tinnitus (ringing in the ears), rash, lightheadedness, syncope (fainting), or the like. Subjective symptoms or physical findings are preferably classified in accordance with a robust medical language like SnoMed . Ontogeny becomes important since it can often be represented in vague terminology (e.g., foot swelling) which might have multiple etiologies or subsets. It is important to recognize that many subjective symptoms or physical findings will cross-reference to the most widely used classification of disease, known as the ICD9 (International Classification of Disease, Ninth Edition). However, the ICD9 is a macro-list of broad clinical terms used primarily for insurance billing purposes, and is physiologically incomplete from the perspective of medical decision support. Even if ICD9 were complete from a scientific perspective, ICD and SnoMed are merely a catalog of terms, and not a decision support/inferencing system.

The Chief Complaint dimension is particularly important for the development of a list of diagnostic possibilities (also known as a differential diagnosis and termed DDx herein) that should be considered for each of the subjective symptoms or physical findings. Generating a differential diagnosis, in the context of the invention, precludes the physician from overlooking an important diagnosis and, more particularly, from overlooking a particular potential disease with which a particular drug treatment regimen may interact, thereby compelling a patient alert.

The History of Present Illness (HPI) dimension relates to particular questions asked to the patient specific to the Chief Complaint discussed above, and related to it. Each particular string of questions has a unique symbolic representation and a well defined set of possible values. Since there is no currently existing data base which provides a standard, uniform string of questions (e.g., worse with spicy foods?), a unique data base is provided, in the context of the invention, in which each string of questions has a unique representation and a set of possible result values. For example, in connection with a CC of chest pain, the HPI dimension would be represented by a string of questions Q1, Q2, . . . Qn, each having a well-defined set of possible result answers. Q1 might equal the string “worse with spicy foods” to which the possible answers (A1, A2, A3) might be yes, no, and not sure, respectively. Q2 might equal the string “history of trauma to the chest” with result values (A1, A2 and A3) being serious, minor or no, respectively. The query response canto continues until the final question Qn is cleared with a noted response.

The Past Medical History (PMEDHX) dimension is a list of co-existing, known diseases associated with a particular patient. In an ideal situation, a physician is able to determine each disease in a rigorous fashion (in accordance with a SnoMed classification, for example) but in most practical scenarios, co-existing diseases will likely be numerically encoded in accordance with ICD9 definitions, since these are insurance industry standard codings which a physician has likely used for billing purposes. Additionally, there will be patients for whom no rigorous medical history has been developed, but the patient believes they know what he/she has.

In accordance with the invention, there might be two categories of responses to a PMEDHX dimension, a limited utility response, such as “heart problem” and a non-ideal, but low utility response, such as “high blood pressure.” Ontogeny can be particularly useful in this particular context, since PMEDHX is, along with medications, one of the more crucial patient dimensions in terms of prevention of catastrophic medical errors. Co-existing disease has a particular clinical implication when it is understood that a co-existing disease, combined with a medication, can be lethal or cause serious or irreversible harm.

The Past Surgical History (PSURGHX) dimension relates to surgical operations performed on the patient. All surgical operations are clinical procedures which are classified by various standard catalogs, such as the American Medical Association's current procedural terminology (CPT ) coding system. Each possible surgical procedure has numerical ID associated with it and most will have been coded as CPT definitions, since these are the ones a physician has likely used for billing purposes. In a manner similar to Past Medical History, above, there will be a certain number of patients for whom no rigorous surgical history has been developed, but the patient believes they know what he/she has had performed. Unlike the Past Medical History context, patients generally have a very accurate idea of what they have had done surgically.

The clinical implications of the Past Surgical History dimension are particularly useful, in the context of the invention, in further narrowing a differential diagnosis (which can determine initial empiric drug therapy) and/or developing a drug-condition interaction or further refining a drug-disease interaction. In particular, associated complications might be determined as the cause of the Chief Complaint (e.g., maldigestion due to removal of stomach). Associated conditions could be caused by a surgical procedure (e.g., anemia following stomach surgery) and differential diagnoses and associated probabilities can be included or excluded based on a past surgical history. For example, stomach pain cannot be due to an infected gallbladder if it has already been removed surgically. Hence a medication such as ursodiol, commonly used to treat gallstones and their symptoms, is not an applicable therapeutic option.

The Family History (FAMHX) dimension is a data set of known genetically based health abnormalities which can be represented symbolically along with a strength of association as a waiting option (all close relatives versus rare, distant relatives). Presently, there is no conventional data base of FAMHX terms. Such a data base is created and mapped to Snomed terms at the highest level of ontological classification (e.g., family history of heart attacks). Strength of association is carried as a weighting factor. For example, a family history of breast cancer might be identified as the set header “breast cancer,” with waiting factors A, B, . . . X, Y, referring to association strings such as “A=strong family history in near relatives, B=strong family history in distant relatives X=possible family history, and Y=no history,” or the like. Clinically, positive family history has certain implications for patient treatment in general and optimization of a drug therapy regimen in particular. Positive family history can be correlated to an increased likelihood of the disease being present which narrows the differential diagnosis or increases the probability of a specific diagnosis within the DDx.

The Social History (SOCHX) dimension corresponds to certain social factors such as use of tobacco, drugs, alcohol, occupational exposures to asbestos, coal dust, and the like. It is contemplated that there are approximately 200 SOCHX data elements which will comprise the top level elements of an SOCHX data base. Each of the data elements can be symbolically represented into distinct categories. For example, if the data element represents smoking history, it can be further categorized in accordance with a severity metric which might range from A=>50 pack years to E=rare or social use only.

Clinically, the presence of a severity metric related to a Social History data element tends to increase the likelihood of a disease, associated with that data element, being present. Effectively, an appropriate Social History metric narrows the differential diagnosis or increases the probability of a specific diagnosis within the DDx. Further, a positive SOCHX for specific diseases necessitates appropriate medical management in a manner similar to FAMHX, described above. Particularly, if the data element “smoking history” has a severity metric of A=>50 pack years, B=20-50 pack years, or C=5-20 pack years, use of certain medications may well be precluded due to a potential risk to lung function.

The Medications (MEDS) dimension is one of the most critical dimensions that a physician needs to consider in the course of developing a drug therapy regimen for a particular patient as well as preparing an individualized pharmaceutical information bulletin. The importance of this dimension in a clinical setting will be particularly understood when it is considered that side effects of medications can often be the cause of the Chief Complaint, and certainly should be highlighted to a patient in an information bulletin. Further, medications combined with other medications (drug-drug interactions) can be lethal or cause serious or irreparable harm in certain cases. Similarly, medication combined with a medical condition (such as low serum sodium) or with a medical disease (heart murmur) can be lethal or cause serious or irreparable harm. In a statistically significant portion of the patient population, certain medications require screening for serious side effects which, if not performed, can have lethal or serious and irreparable consequences.

All FDA approved medications, for use in America, are classified according to the National Drug Code (NDC) catalog and each are assigned a unique numerical ID. Further classification of each medication is based on regimen (frequency and dose) which have implications for recommendation of other therapies due to possible interactions. It should also be understood that the “effective” dose of a medication is also a function of the route by which it is introduced. Medication entry into the system of the invention includes all of the above-noted classification options. For example, a particular medication entry might be Penicillin Potassium (ID=2492311), 500 mg., 4 times per day, orally. Thus, MEDS are evaluated in accordance with their identifier, dose, frequency, and introduction route.

The Allergies (ALLER) dimension is also of particular importance in the context of the present invention. It is well known that allergic reactions often have fatal consequences. Additionally, there are approximately 300 broad classifications of ALLER data elements of which patients will likely be aware. These include reactions to dust mites, food substances, copper, pollen, or bee stings. In addition, there are known specific allergic reactions to medications, most of which are contained in the National Drug Code (NDC) catalog. Some additional complexity is introduced because if a patient states an allergy to Morphine, for example, there might be over twenty specific medications that contain Morphine or have a cross-allergy indication (a beta-lactam cephalosporin with Penicillin, for example).

A unique symbolic element is created for each type of allergy, whether food, drugs, a drug class or environmental factor. The impact of that allergy element on a particular patient is scored according to the severity of that patient's reaction. For example, a particular patient might have an allergic reaction to Penicillin with a severity of 2, but an allergic reaction to copper with a severity of 9. Another patient may have an allergic reaction to copper of 1, but an allergic reaction to the sulfa drug class of 7. Thus, the ALLER dimension is particularly important in narrowing or strengthening a differential diagnosis, but even more particularly important in developing and/or defining an allergy-drug interaction metric.

The Review of Systems (ROS) dimension relates to a list of questions that are generally related to CC, but which are more broad in nature. A well-performed ROS is able to uncover additional medical problems which the patient may have apart from the one he/she is visiting the physician for. An ROS is exemplified by the screening questionnaire a patient often completes when visiting a physician's office for the first time. Exemplary such questions include “do you have any unintentional weight loss?, fever?, etc.” The data base elements relating to ROS is generally short and comprises approximately 2,000 data elements. Comprehensive summaries of ROS elements can be found in many standard medical textbooks.

A positive ROS is also able to generate a second differential diagnosis, independent of the CC, which should demand a physician's attention. Quite commonly, a patient may consult a physician for a CC for a relatively minor complaint, a cut finger for example, and an ROS discovers another serious illness (a heart problem exposed by chest pain) unrelated to the Chief Complaint. Practically, because ROS are questions, most can be asked by a nurse or medical assistant in layman's terms, thus removing some of the work load from the physician.

Again, it should be noted that initial drug regimens are often empiric and based on symptomatology suggesting a most probable diagnoses, even when an exact diagnosis is not known. Hence it is important to be able to include subjective, physical exam, family, and social history dimensions into a computerized system when determining initial treatment regimens that are patient specific and also optimized based upon context. In the case of pharmacotherapy, the ROS dimension plays an important role as frequently one drug is commonly used to prevent the side effects of a co-administered drug. For example, persons taking high dose steroids for immune disease will often need anti-acid therapy to prevent stomach ulceration, and even aggressively so if they describe having abdominal pain or have iron-deficiency anemia present (signs of a bleeding ulcer).

The Vital Signs (VS) dimension includes objective, numerical demographic parameters such as a patient's age, sex, weight, blood pressure, heart rate, respiratory rate and height. Since these parameters are all objective numerical values, no data base is necessary and they may be entered directly into the system. Important medical criteria for screening for important diseases are often associated with the age metric. Even in the absence of disease, age is associated with important changes in the effectiveness and dosing of various drugs. Similarly, weight, blood pressure and heart rate will often inform a drug therapy regimen, particularly if the drug is devised as affecting one of these metrics. High blood pressure and heart rate, for example, will often preclude use of certain weight reduction drugs. In pediatrics, weight is typically the most crucial dimension in terms of drug dosing.

The Physical Exam (PE) dimension relates to the presence or absence of physical exam findings which, in turn, are able to increase or decrease the probability of a particular disease being present. This, in turn, can affect the choice of medications to be employed in any particular drug therapy regimen. For example, a critically ill patient with a systemic petechiae (bruising) is likely to have a blood coagulation disorder and hence should not be administered medications which may cause further thinning of the blood. The presence of certain physical exam findings may have implications for appropriate diagnostic evaluation (particularly in the context of a differential diagnosis). A narrowly defined differential diagnosis has further implications on a drug therapy regimen, as will be described in greater detail below.

Lastly, the Diagnostic Tests (LAB) dimension is directed to results of diagnostic tests such as serum chemistry, blood count, and x-rays. There are currently about 10,000 diagnostic tests available to the contemporary physician, of which approximately 500 are commonly performed. The results of diagnostic tests can dramatically affect a particular drug therapy regimen. For example, a patient with a very low serum sodium should not receive a mediation which has a side effect of lowering sodium even further. This is potentially lethal. Alternatively, if the patient is positive for possession of the BRCA1 gene, it may alter the specific components of chemotherapy desired for breast cancer treatment. Indeed, it is likely that the future of medical therapy for cancer will depend upon the genetic makeup of the particular individual.

In operation, the system, according to the invention, operates upon the various clinical dimensions (input variables) described above, in order to make determinations as to any possible drug-drug, drug-disease, drug-allergy, drug-condition, and drug-diagnostic test interactions that apply and further to make recommendations as to a set of particularly effective and safe drugs in any given case. These operations are performed in accordance with a table or database element set of inter-dimensional relationships that define known and characterized drug-drug, drug-disease, drug-condition, and even drug-diagnostic test interactions.

In the present invention, important inter-relationships between the clinical dimensions are first mapped topologically, and encoded with a severity score which signifies the strength of the link. For example, the presence of the drug Clozaril (MED dimension) is linked to the LAB dimension for the diagnostic test known as the complete blood count (CBC) which is used to test for the drug's serious side effect. The strength of the association is stratified according to severity score, in which the relationship might be characterized as (1) weak, (2) strong, or (3) mandatory. A multitude of severity scores can be used with differing weights based upon clinical utility.

The strength of an association (severity) can be either subjective or objective, based upon the body of knowledge which supports the recommendation. For example, the FDA may state that all patients on Clozaril have a CBC test performed at least every 3 months, and failure to do so constitutes substandard care. The mechanism by which the strength parameter is determined is not central to this discussion; only that such a parameter is specified for purposes of the invention. This topological map, including strengths of association between dimensions, is subsequently combined with entities that can exist within a dimension. For purposes of simplicity and ease of explanation, one can assume that each element symbol is represented by a unique numerical code.

For example, suppose the condition of pregnancy=1234567(PMEDHX dimension), the drug Accutane=425372 (MED dimension), the drug Demerol=999111 (MED dimension), the drug phenelzine=400 220022 (MED dimension), removal of the spleen=555666 (PSURGHX dimension), folic acid=248612 (MED dimension), and that a vaccine against streptococcal pneumonia=987654 (MED dimension). Given the foregoing, one might further assume that the following medical facts are known: Accutane causes severe birth defects in pregnancy and it is absolutely forbidden to use in this situation as the patient is pregnant. This implies that a combination of (MED dimension=Accutane)+(PMEDHX dimension=pregnancy) would absolutely preclude prescribing Accutane in this patient.

Likewise, use of Demerol in a patient taking phenelzine can cause life-threatening seizures and therefore should never be administered. Again, this compels a combination of (MED dimension)+(MED dimension) to return an output dimension that absolutely precludes prescribing this combination for this patient. Additionally, patients who have had their spleen removed should be vaccinated against streptococcal pneumonia because they are at high risk of meningitis, pneumonia, and death, and these are preventable by vaccination. In this case, the system according to the invention is able to evaluate a combination of the (PSURGHX dimension=spleen removal) and (MED dimension=pneumococcal vaccine) to determine that the patient has not been previously vaccinated and that a vaccination regimen is definitely indicated.

The various rules which govern the methodology of the present invention are derived from what might be termed the “Rule Book of Medicine” which contains a compilation of recognized medical therapies, including medication therapies, as well as an indication of absolute and relative contraindications for the various therapies and medications. The “Rule Book of Medicine” is generalized term which subsumes all of the information contained within the various references described above, the Physician's Desk Reference, for example, as well as the various drug labeling instructions, approved and disseminated by the USFDA, including absolute and relative contraindications as defined (approved) by the FDA. Additionally, the “Rule Book of Medicine” includes Class 1 and Class 2 guidelines as defined by the US Preventative Task Force. As will be understood by those having skill in the art, additional sources of therapeutic references may also be added to the “Rule Book of Medicine” in order that the rule book be as complete as possible with respect to the universe of medical therapeutic knowledge.

Initially, the methodology of the invention defines the medical “rules” as found in the rule book in terms of symbolic logic and also with respect to the actual language found in the rule itself. This last is necessary because there is presently no consistency of terminology from rule-to-rule. Because of this inconsistency, it is desirable to have every rule term listed in the rule database, for example, with pointers linking thesaurus equivalents to one another and also grouping various equivalent terms into classes or categories, for which any given term might be a subset. As will be described in greater detail below, concept normalization of inconsistent medical terminology is an important feature of the methodology of the invention and supports a particularly efficient form of decision support.

In context of the invention, all of the medical terms which are found in the “Rule Book of Medicine” are listed in a relational database. As a term is listed, it is initially determined whether that term is a categorical term or an “irreducible medical term”. For purposes of this specification, a categorical term is defined as one which includes a plurality of irreducible medical terms, many of which may be different, and many of which may be synonymous with one another. An irreducible medical term is defined as one which may have a synonym or synonyms, but which nevertheless completely identifies a particular relevant medical item such as a specific drug, a surgical procedure, a particular disease, condition, and the like.

For example, bacterial meningitis is a well recognized term for a particular disease. Accordingly, bacterial meningitis might be viewed as an irreducible medical term since it identifies a particular disease (bacterial meningitis) and no other. Meningitis has a number of synonyms which might be found in various rule book terminology; examples of such synonyms are infectious meningismus and I.M. Accordingly, when the terms I.M., infectious meningismus and/or bacterial meningitis are found in various rules, pointers link these terms together as synonyms and also identify the term bacterial meningitis for example, as the irreducible medical term to which these synonyms relate.

It is also well understood that the disease meningitis is one of a number of central nervous system diseases (alternatively central nervous system disorders) allowing bacterial meningitis to be classified within a class or category of central nervous system diseases. Thus, it should be understood that the class of central nervous system diseases would include the irreducible medical term meningitis, as well as other irreducible medical terms relating to various other specific diseases subsumed within the classification or category of “central nervous system disorders”. It is also axiomatic that these other irreducible medical terms will also necessarily have various synonyms, as will the classification “central nervous system diseases” itself. Thus, the database will be understood to define many-to-many relationships between and among its content items.

Taking the classification system to yet an additional conceptual step, it will be realized that meningitis is also subsumed within the classification of “spinal cord and brain diseases”, as well as the classification of “severe infections”. Additionally, meningitis may be categorized as an “inflammation of the meninges”. Indeed, meningitis might be categorized as belonging to any one of a number of different general classifications, depending solely on whether that classification term appeared in any of the rules developed from the universal “Rule Book of Medicine”. Specifically, if the term “inflammation of the meninges” was found anywhere in the “rule book”, that term would be included as a classification in the database of the present invention. Thus, category or classification definition is driven by the contents of the rule book and not by an arbitrary structural definition. Likewise, synonyms to an irreducible medical term are also driven by the contents of the rule book. As any term is developed from the rule book, it is entered into the database and a determination is made whether it is a synonym to an irreducible medical term, itself an irreducible medical term, or a categorical term within which irreducible medical terms, or even other categories, are collected.

Thus, for all terms entered, concept normalization involves definition of all equivalent terms for the entered term as well as definition of all classes or categories for which the term is a subset. As an additional example, the term hypokalemia is equivalent to “low serum potassium” which is, in turn, a subset of the category of “electrolyte disorders”. Electrolyte disorders represent a class or category of disorders of which low serum potassium and/or hypokalemia are subsets. In this particular case hypokalemia might be identified as the irreducible medical term for which low serum potassium is a thesaurus equivalent.

Medical term entry is further performed as part of a medical rules definition process, in which each of the medical rules found within the “Rule Book of Medicine” are defined in terms of symbolic logic. For example, one of the rules that might be found in the universal body of medical knowledge, is that the use of Demerol™ in a patient taking phenelzine can cause life threatening seizures and these two medications should never be administered together. In terms of symbolic logic, this particular rule might be written as:

IF (drug)=[Demerol] AND (drug)=[Phenelzine] THEN [Flag]

In this particular case, [Flag] might represent a pointer to an absolute contraindication, a relative contraindication, or might indicate that the combination of the two drugs are okay (i.e., a [NULL FLAG]). It is also informative to recognize that the argument of the IF and AND expressions is characterized in symbolic terms as an undifferentiated drug. In terms of the invention, the input clinical dimension (MED) will be understood to substitute for the argument (drug). Thus, the “rule” is made relevant to any medications taken by a particular patient. All that is required to invoke the rule is that a patient have an input dimension that corresponds to the argument (drug). If the (MED) dimension includes an entry, but not for either Demerol or Phenelzine, the results for the IF and AND expressions are [NULL]; thereby giving a [NULL FLAG]. In other words, the rule is not invoked. It should be emphasized that in the present invention (by its very construction), all rules can be converted to reasoning-enabled symbolic logic as all possible dimensions have been defined and symbolic terms assigned to each possible variable, and a meta-thesaurus of synonyms and ontogeny are included to avoid ambiguity.

Each of the rules found in the “Rule Book of Medicine” are expressed in this form and all of the terms found within the rule are added to the terminology database. Equivalents are set for categories and irreducible medical terms; categories are assigned to categories; irreducible medical terms are assigned to categories; and irreducible medical terms are also assigned to irreducible medical term equivalents (synonyms), if appropriate, in accordance with each rule. Necessarily, the number of equivalent terms, as well as the number of categories, are defined by the rules themselves.

In order to simplify the process, each of the terms contained within the terminology database are assigned a unique set of symbols. The symbols might be numeric or alphanumeric, or any other unique symbology set, so long as each term is converted into a unique symbol, including all medical terms and all medications. By way of example, the term “penicillin” might be assigned the symbol “126473” while its equivalent forms “trade names, salts, and the like” would each be assigned a different symbolic representation, as would the class of Beta Lactam drugs of which it is a subset. In this regard, use may be made of identification codes found within ICD9, or other suitable classification source, but only if they result in every term having a unique symbolic value.

It should now be realized that the various clinical dimensions discussed above have a direct relationship to the terms and terminology used in connection with rules defined in the “Rule Book of Medicine”. For example, the MED dimension relates to medications and or drugs, and an initial data entry associated to the MED dimension will necessarily invoke one of either the irreducible medical terms or equivalent terms associated to the particular drug or medication entered. Likewise, the PMEDHX dimension relates to terminology found within the rules that corresponds to aspects of a past or present medical history, for example, pregnancy. Similarly, terms associated with allergies (the ALLER dimension) and a surgical history (the PSURGHX dimension) are all assigned a corresponding database entry and unique symbol representation, such that any “rule” (by definition) expressed in language form can also be expressed in terms of logical symbology which can be implemented using a computer.

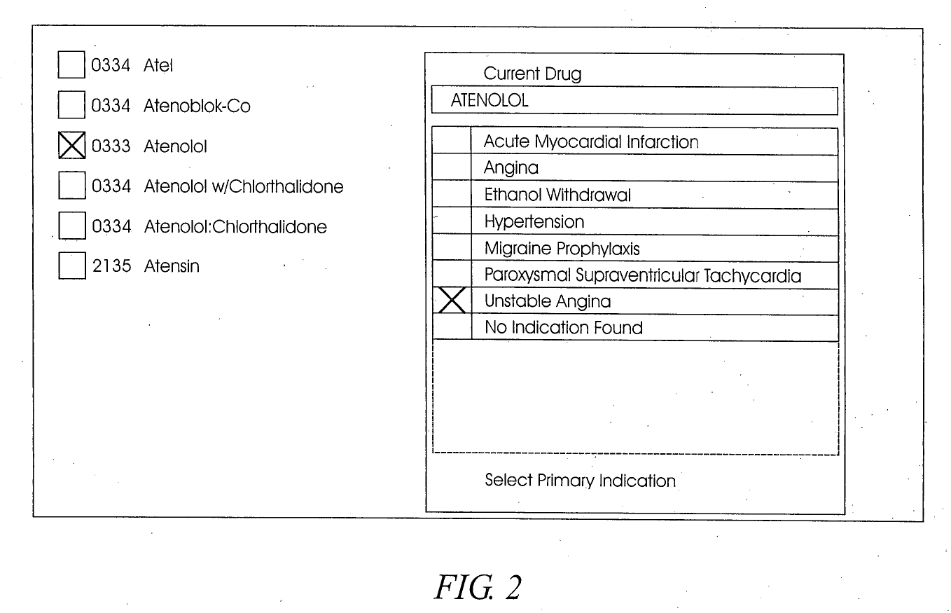

In an initial portion of the methodology of the invention, as depicted in the exemplary embodiment of FIG. 2, a patient (or a physician or medical assistant) enters, at least, any and all of the mediations that are currently being taken by the patient into a computer system, either through direct text entry or by using a scannable paper form which converts data into an electronic format (a scannable bubble sheet, for example). Alternatively, it may also be assumed that the physician has this information available for the patient in machine recognizable form. The information may have been entered during a previous visit, or acquired from a previously prepared electronic medical record. Since medications are often identified by multiple names, e.g., different trade names and a generic name, the medication input data is normalized to account for various differing identifying names for the same medication. Normalization is the terminology used to describe the accounting process which takes place upon data entry of any one of an item's trade names, chemical description or generic name.

For example, atenolol, a synthetic beta-selective adrenal receptor blocking agent, might be known by the trade name Tenormin, or by its chemical description (atenolol) which is also its generic name. Data normalization ensures that however the particular medication is described, it is related to a particular identifying index which is generally based upon both the chemical name and the manufacturer, who may use different carrier vehicles that convey additional physiological properties that are significant clinically.

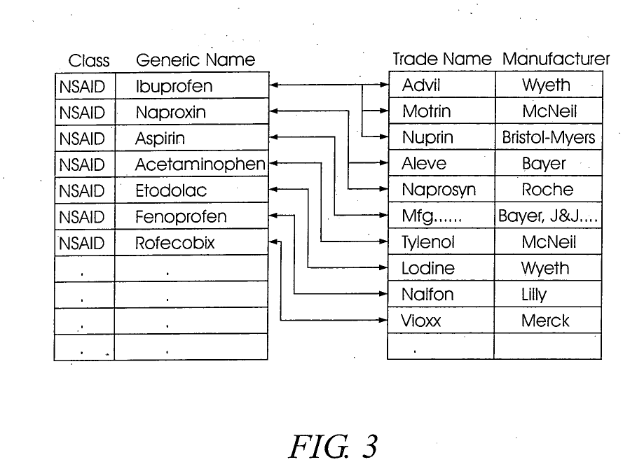

Specifically, and as indicated in the exemplary embodiment of FIG. 3, a normalization database is a many-to-many relational structure, with three significant groupings, each of which reference the others through multiple relationships. The three basic groups include a trade name grouping, a manufacturer grouping and a chemical composition (generic name) grouping. Elements in each of the three groupings are related to one another by pointers that might associate the trade name Tenormin with the generic medication atenolol. In the exemplary embodiment of FIG. 2, for example, the generic name portion might include a listing for the term ibuprofen which is associated with various manufacturers such as Bayer, Johnson & Johnson, and the like, each of which might market the product under various trade names such as Motrin, for example. Thus, ibuprofen is associated to various trade names by pointers directed to the manufacturer portion of the database and thence to the trade name portion.

Thus, it can be understood that a particular manufacturer might market a particular generic medication under various trade names, each of which might use a different carrier vehicle for the generic medication. Additionally, each manufacturer is associated to several different generic medications and to the trade names associated with those various generic medications. Accordingly, the data normalization database ensures that no matter how a particular medication is characterized, the data is associated to a particular identifying index, typically the generic name or chemical description of the medication. In this regard, it should be noted that the database need not include any manufacturer information portion in order to retain its functionality. As those having skill in the art of database design will immediately recognize, the database might be suitably constructed with pointers directly linking a medication's generic or chemical name to each of a collection of trade names that contain the generic chemical agent. Including a manufacturer designation is for purposes of convenience, and to allow expansion of the functionality of the invention to include contraindication alerts based upon carrier vehicle incompatibility, for example.

Generic agent name to trade name linkages may also be made through a classification index, for example. Penicillin and amoxycillin both belong to the class of beta-lactam antibiotics. These antibiotics and their respective trade names can be cross-linked to one another by virtue of their joint membership in the class of beta-lactam antibiotics, with database pointers directed in both directions. Thus, entry of a particular trade name returns either a generic/chemical name, an effectivity classification name, a set of generic/chemical names of agents belonging to the classification, or any desired combination of the foregoing.

In a further extension of the methodology, allergies and allergic reactions to particular medications, drugs, therapies, or the like, are treated in a substantially similar fashion, with a drug allergy, e.g. to penicillin, being identified as an allergic reaction to a class of beta-Lactam antibiotics. In this particular situation, an additional database portion, a medication classification portion, is included in the normalization database and functions to assign each of the generic (chemical) name medications to a particular classification. Accordingly, an indication of penicillin hypersensitivity would suggest a sensitivity to other medications in the beta-Lactam antibiotic classification. Thus, penicillin hypersensitivity would be associated amoxycillin, as well.

Once a particular patient's medication (and allergy) program have been entered, the normalized data is matched to a number of possible indications (macro diagnoses) that are associated with any particular medication in a process termed “reverse-indexing”. As will be understood by those having skill in the art, drugs, medications and therapies all must be approved by the U.S. Food and Drug Administration (FDA) for use as treatments for particular indications. For example, amoxicillin is considered a drug of choice for the treatment of acute sinusitis, acute otitis media, and of acute exacerbations of chronic bronchitis. Amoxyicllin is also suitable for treatment of streptococcal pharyngitis, and is important as an alternative to co-trimoxazole for uncomplicated infections of the urinary tract (particularly as a single dose for non-pregnant women).

In this particular example, the National Drug Code (NDC), a unique catalog of every medication which is FDA-approved in the United States, combined with other data ubiquitously available from the FDA, is able to provide the basis for an FDA-approved indications database, with various drug formulary entries associated with their corresponding indications. Conventionally, physicians select a medication on the basis of an observed indication, but in the context of the invention, medications identify their corresponding indications which are presented to the physician as a reverse-index of discrete choices of macro diagnoses.

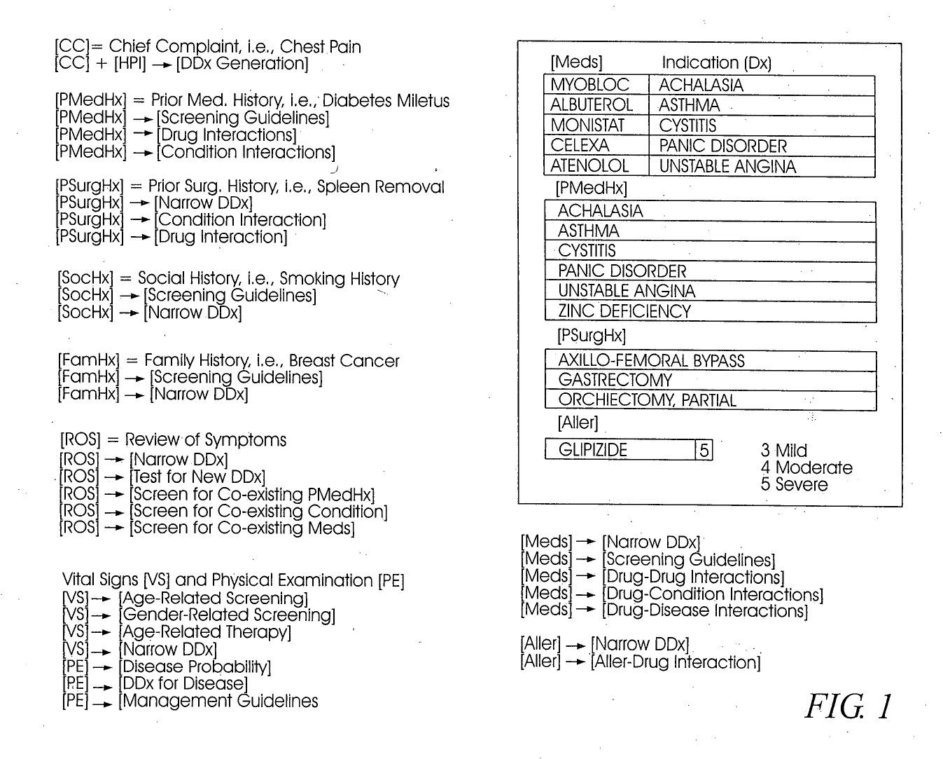

Indications or macro diagnoses are a collection of relatively descriptive terms, typically cast in lay person's language, which describe a particular disease or condition without regard to precise medical terminology. For example, and in accordance with the exemplary embodiment of FIG. 1, indications for atenolol include acute myocardial infarction, angina, ethanol withdrawal, hypertension, migraine prophylaxis, myocardial infarction prophylaxis paroxysmal supraventricular tachycardia, and unstable angina. If a patient is taking atenolol, the system is presented with these possible indications (macro diagnoses) from the indications that database, as a result of an “atenolol” entry into the system.

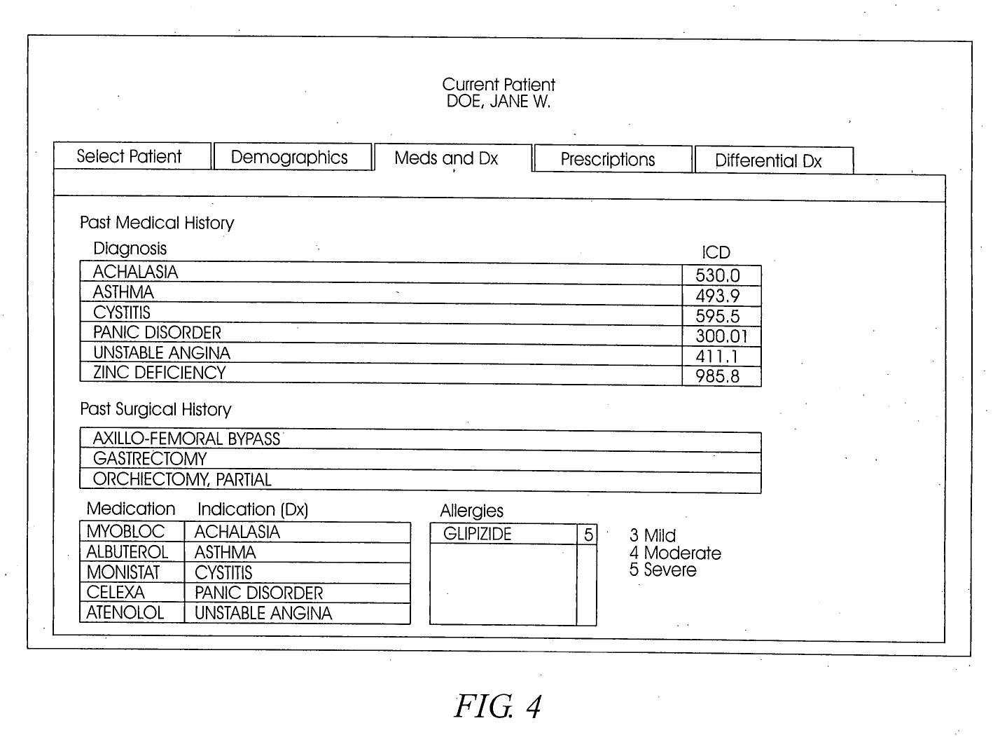

The exemplary embodiment of FIG. 4 depicts an arbitrarily organized screen shot of a suitable electronic patient record which is organized to depict the patient's past medical history, past surgical history, medications and allergies, in separate window portions. As described above, each of the entries, for each of the clinical dimensions, is able to invoke a “rule”, so long as the “rule” contains an entry, synonym, category, or other analog, for an entered medication, disease, allergy, procedure, or any other clinical dimension entry as exemplified in FIG. 1. Following the example of FIG. 2, an entry has been made for “Unstable Angina” in the patient's past medical history record. Also, an entry for Atenolol appears in the patient's medications listing, with “unstable Angina” being given as the indication for which the medication is being taken. Each of the patient's diagnoses is associated to its corresponding ICD9 code. For example, Cystitis has an ICD9 code of 595.9; zinc deficiency has a code of 985.8. It will be seen that Unstable Angina has a code of 411.1.

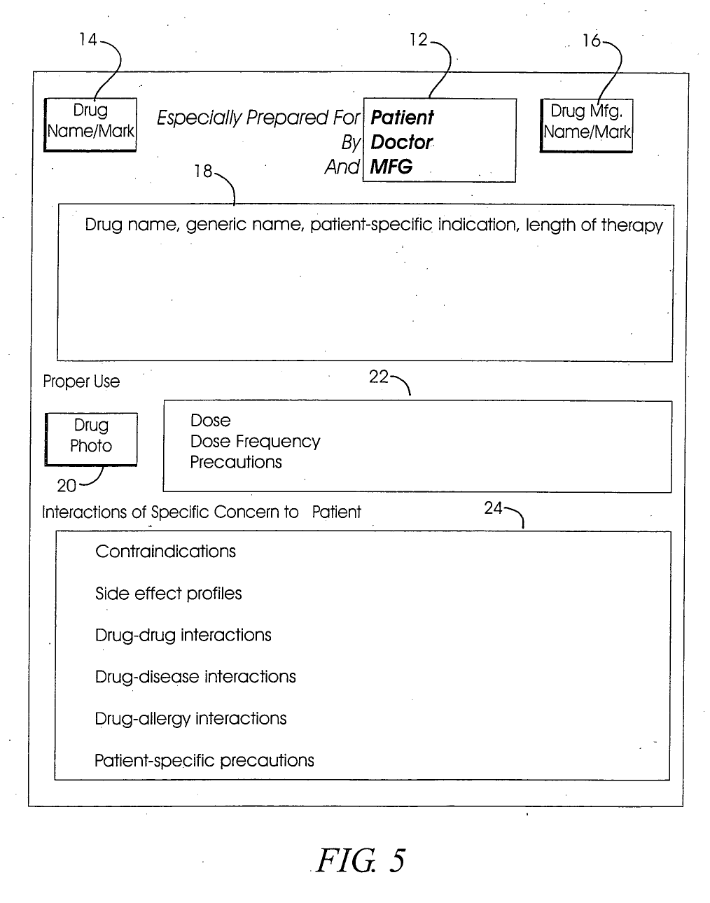

The foregoing description is considered important in the context of the present invention, since the various databases and rules form the information “pool” from which patient-specific prescription drug safety information is extracted. In the context of the present invention, and in connection with FIG. 5, the patient-specific prescription drug safety information bulletin is suitably configured as a document template into which the individualized prescription drug safety information is formatted. Generally, the document template 10 may be provided as an HTML document, a JAVA script document, a text processing document shell, or any other formattable document shell into which text, or graphics, or both, may be merged, combined or otherwise embedded. The document template 10 is suitably divided into information areas into which particular kinds of drug related information are captured and presented to the patient.

A header area includes space for identifying the various entities that are involved with the particular bulletin. For example, an ID field 12 might be preceded by text such as “Especially prepared for: by: and:” followed by a data entry block that shows the patient's name, the doctor's name and perhaps also the manufacturer of a particular drug, if the drug is being prescribed under a tradename. In the case of a trademarked product, a drug name/mark field 14 is able to capture and show the drug's tradename, along with any trademark associated therewith, as well as a chemical description (or generic name) of the drug. Where the prescribed drug is a generic, the drug name/mark field 14 only indicates the drug name and any chemical composition information associated with the generic name. Further, in the case of a trademarked product, a drug manufacturer field 16 is able to capture and show the manufacturer's name and/or house mark. Necessarily, if the drug is a generic, this field is left unpopulated as well as the manufacturer name in the ID data block 12.

All of the information contained in the header area is extracted from the system databases as entries in response to arguments of one or more clinical dimensions. For example, it will be assumed that the physician has made an appropriate diagnosis and has determined an appropriate drug therapy regimen in accord with the systems and methods described in co-pending U.S. patent applications Ser. Nos. 10/350,483 and 10/351,083, entitled SYSTEM AND METHOD FOR PATIENT-SPECIFIC OPTIMIZATION OF MEDICAL THERAPY BY SIMULTANEOUS SYMBOLIC REASONING IN ALL CLINICAL DIMENSIONS, and COMPUTERIZED SYSTEM AND METHOD FOR RAPID DATA ENTRY OF PAST MEDICAL DIAGNOSES. Once an appropriate drug therapy is defined, all the information is available in the databases for population of the template. The patient's name is extracted from a [NAME] argument of the patient vital signs dimension, for example, while the drug's tradename, generic name, chemical composition, as well as manufacturer designation are extracted in response to the [MED] argument of the medications dimension. The normalized drug database, described above in connection with FIG. 3, contains all the necessary pointers between tradenames, generic equivalent names and manufacturers, to enable the system to acquire a generic name and manufacturer data upon input of any tradename. Suitably, the drug database can incorporate a graphic image file of a manufacturer's house mark, associated to the manufacturer name, which can be extracted therefrom and plugged into the appropriate field of the template.

The template further includes a drug description field 18 which is configured to capture and display detailed information relating to the prescribed drug. Information presented in the drug description field includes the drug name, the drug's generic nomenclature, the drug's active ingredient, a description of the drug's activity in connection with the patient-specific indication for which it was prescribed, and an indication of the particular supply prescribed and therapy length (i.e., a 90 day supply with 2 refills only). In accord with the invention, the information contained in the drug description field relates to the use of the drug in connection with the specific indication for which it was described. This is a particularly advantageous feature, since many drugs are effective for treatment of different and often unrelated indications. Atenolol, for example is used to treat hypertension and migraine headaches as well as atrial fibrillation and congestive heart failure. It is important, therefore, that a patient-specific drug safety bulletin put the drug activity description in the appropriate context.

This is done by referencing the differential diagnosis (DDx) made in connection with definition of the drug prescribed. As is well known by those skilled in the art, pharmaceutical products have activity bulletins prepared by their manufacturers which describe the action of the product in connection with all of its approved indications. Additional such information is available from the various drug labeling instructions, approved and disseminated by the USFDA, Class 1 and Class 2 guidelines as defined by the US Preventative Task Force, and the National Drug Code, among others. Since drug activity can be characterized as a “rule”, it is a simple process to enter drug activity as a text string in response to a [DDx] related [ACTIVITY] argument for a drug, and extract the text string in response to “ANDED” combinations of [DDx], [ACTIVITY] and [MED] arguments of the medication clinical dimension.

Therapy length and drug supply can be manually entered by a physician by defining a “therapy length and supply” subfield which is populated in response to an entry made to an electronic data terminal device (a desktop, laptop, or palmtop computer, for instance) with which the drug safety information bulletin is prepared and/or printed. The entry might be simply made in response to a structured screen query, such as “______ day supply; ______ refills”. The entered numbers are simply transferred to corresponding places in a standard text string of the template.

A dose field 20 defines an area in which drug dose information, pertinent to the patient, is presented. The dose field includes information relating to the drug dose itself (e.g., “50 mg tablet”), the dose frequency (e.g., “1 tablet daily”), any precautions that the patient must take (e.g., “take with food; no alcohol; etc.”), and any special instructions regarding missed doses (e.g., “return to normal schedule, do not double dose”). These fields are necessarily text string fields and have standard language. They may be returned as database responses to additional [MED] arguments or, merely selected from a list of text strings presented to a physician on his/her data terminal device.

Optionally, a photograph of the prescribed drug is included in a “drug graphic” field 22 disposed near the dose field. Having a photograph of the drug available for viewing is often beneficial, since many individuals are taking multiple medications and being able to make a visual identification of a drug and relate it to its safety bulletin would give those individuals an additional level of comfort.

The particular fields described above may be characterized as administrative in nature since, with the exception of the patient-specific indication information of the drug description field 18, the data is concerned mainly with simple “identification-based” processes and is not necessarily derived as a result of a “reasoning-based” process. By way of contrast, a particularly important information field, the interaction data field 24 comprises information that has been developed by symbolic reasoning across multiple clinical dimensions in order to define a listing of various interactions, side effects, and precautions, of specific concern to the patient, with respect to that patient's pre-existing medications, diseases, allergies, and the like.

The interaction data field 24 is populated by information obtained by drug-drug, drug-disease, drug-allergy, drug-condition interaction checking in the manner described above. Once the specific drug being prescribed is made known to the system, the system carries out contraindication and interaction evaluation in accord with the entire set of “rules” with which it has been programmed. The system makes use of substantially all of the particular patient's clinical dimensions, particularly the Chief Complaint (CC), History of Present Illness (HPI), Past Medical History (PMEDHX), Past Surgical History (PSURGHX), Family History (FAMHX), Social History (SOCHX), Medications (MEDS), and Allergies (ALLER) clinical dimensions. The system looks for any rule that includes the drug being prescribed [DRUG A] in combination with any other element, that exists in the patient's clinical dimension entries, for which there is a [FLAG]. Thus, if the patient is also taking Drug K, and there is a known interaction between B and K, the system will be expected to find a rule written symbolically as follows:

If [DRUG A] AND [DRUG K] THEN [FLAG]: where [FLAG] points to an interaction.

The interaction may define a relative contraindication, such as certain potential side effects that may obtain with the combination, but may also define an absolute contraindication, such as a substantial risk of birth defects in the event of pregnancy.

Additionally, the exemplary rule, above, might also appear as:

If [DRUG A] AND ([SEX]=Female) THEN [FLAG] or:

If [DRUG A] AND ([CONDITION]=Pregnant) THEN [FLAG]

indicating a possible risk from an otherwise benign medication, if the female patient becomes pregnant, thereby requiring a precautionary notice, or indicating a substantial risk if, indeed, the patient is pregnant. Notably, in both examples, the [FLAG] is a function of a combination of a drug entry and a gender and/or condition entry. A male patient will not receive a pregnancy caution, since their clinical dimension entries will identify them as male and will be unlikely to identify them as having a present (or past or future) pregnancy condition.

Specifically, the interaction data field 24 provides the patient with information relating to specific timing of medication use in relation to medicines already being taken, drug-coexisting drug interactions, optionally sorted by either severity or frequency, drug-coexisting disease interactions, optionally sorted by severity or frequency, drug-coexisting allergy interactions, based on the patient's known allergies, and patient-specific precautions, such as when to stop or not stop the medication, or any other coexisting medication due to an interaction. Since interactions give rise to side effects, the interaction information can be presented as hierarchical side effect profiles, in which most important (or most frequent) of side effects are listed in order of the probability of their occurring.

In general, and with respect to the administrative informational elements, the template is populated by incorporation of database elements into a string, i.e., a string substitution of database elements. A general text string will include substitution variables that may appear as follows:

“You were give a [DAY] supply of [MEDICINE NAME] on [DATE].”; or

“Take [NUMBER] [DOSE] tablet per [DAY].”

Multidimensional interactions are analyzed and, based on known patient parameters (age, sex, weight, ethnicity, medications, lab test findings, diseases, allergies, past surgical history, and the like) possible interactions are determined, and their associated severity and frequency noted. These are then scored (prioritized) based on clinical relevance. “Reasoning results” are converted to lay-person-intelligible text strings by substitution of ordinary language for irreducible medical terms, or other technical terminology. For example, given the following symbolic rule,

If [DRUG X]=TRUE and [DRUG Y]=TRUE, then print:

“Use of [DRUG X] while concurrently taking [DRUG Y] may cause [DRUG X-DRUG Y INTERACTION EFFECT]”

the variable [DRUG X-DRUG Y INTERACTION EFFECT] might be characterized as “hyperemia of the conjuctivia” in the database of irreducible medical terms. However, suitable pointers between this term and other rule terminology allow for easy conversion this technical term to “painless red eye”, resulting in a text string that may appear as follows:

“Use of [DRUG X] while concurrently taking [DRUG Y] may cause painless redeye.”

In accord with the invention, it will be understood that because the database of medical terminology is relational, it can be very easily analyzed to determine if all medical terms are associated to a layperson-intelligible description. Those terms not having a layperson-intelligible analog can be simply assigned one without undue effort. Once the administrative and “reasoning based” strings are defined, the strings (and any associated images) are assembled, in accord with the template, for printing or assembled into an electronic file for email transfer, for example.

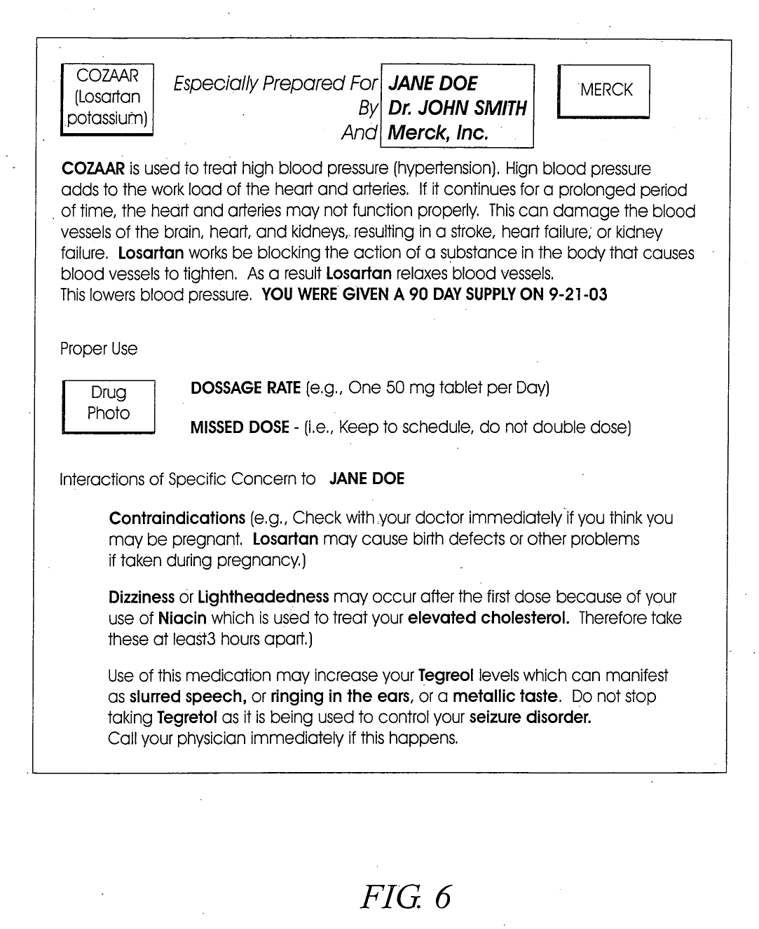

An example of a completed patient-specific prescription drug safety information bulletin is depicted in FIG. 6. The bulletin has been prepared for an exemplary patient, Jane Doe, on account of Dr. John Smith prescribing a trademarked drug (COZAAR) manufactured by the MERCK, Inc. pharmaceutical company. Since the drug being prescribed is proprietary, the bulletin includes its generic name (Losartan) in the description of drug activity. Patient Jane Doe is advised that “you were given a 90 day supply on Sep. 21, 2003”.

The proper use of COZAAR is given on the basis of the dose prescribed (50 mg) and frequency of use (once per day). Missed dose data is also pertinent to the drug and the particular dose rate. Specific interactions between COZAAR and other medications Jane Doe is currently taking include interactions with Niacin and Tegretol. Side effects caused by the Niacin interaction are listed, as well as the indication (elevated cholesterol) for which Niacin is being taken. Since the interaction effects are relatively minor, the patient is given instructions on how to alleviate or reduce their effects (take the medications 3 hours apart). Tegretol, on the other hand, is being used to treat a more severe indication (seizure disorder) and the interaction manifests in more severe effects (slurred speech, for example). Since the indication is severe, and its consequences are life threatening, patient Jane Doe is advised to continue Tegretol use upon side effect appearance, but notify her physician at once if this should occur. Since Jane Doe is female, she also receives a cautionary warning regarding possible contraindications as a result of pregnancy.

In terms of its systematic implementation, the present invention suitably comprises normalization, indication and concept-mapped databases (or unitary database encompassing these functions), hosted on a computer or data processing system of suitable type. The database is accessible to a hand-held, laptop-type or desktop-type computer display for access by a physician or clinical worker. In addition to being hosted on a local data processing machine, the database is also contemplated as being maintained in a centralized data processing server implementation, such that it is accessible through a local or wide area network for download by a physician or practice group. Maintaining the database in a centralized location allows database terminology to be maintained on a more uniform basis, thereby minimizing the present-day confusion generated by inconsistent terminology for both indications and clinically relevant diagnoses. In a manner well understood by those having skill in the art, database contents are also uploadable to the centralized server, by participating physicians or practice groups, so that additions and embellishments may be provided to the centralized system by physicians that may have discovered an additional indications usage for a particular medication and who wish to share this information with the medical community at large.

In addition, the system of the present invention also incorporates an interface to any one of a number of commercially or conventionally available electronic medical recordkeeping applications, such that as a diagnosis is made and medications are prescribed, the diagnosis and medications are automatically ported to the appropriate input port of the medical records program. In particular, the data entry application, and its associated database, are implemented as an application software program that is written with the requisite I/O “hooks”, such that it can be incorporated as an “applet” or “servelet” in a medical recordkeeping program. As patient information is added in conventional fashion, the medical record program invokes the application of the invention as soon as the physician reaches the “medications”, “indications”, or “diagnoses” portions of the recordkeeping program input. Accordingly, the present invention can be understood as defining a particular system and methodology by which a patient's existing medical records can be consulted and analyzed in the context of a new prescription, and a patient-specific drug safety information bulletin can be prepared with minimal cost and minimal time commitment on the part of a physician.

While the above specification has shown, described and identified several novel features of the invention, as applied to various exemplary and illustrated embodiments, it will be understood that the embodiments are for purposes of illustration and ease of description only. Various omissions, substitutions and changes in the form and details of the exemplary embodiments may be made by those skilled in the art without departing from the scope and spirit of the present invention. Accordingly, the invention is not contemplated as being limited to the described, exemplary and illustrated embodiments, but are rather defined by the scope of the appended claims.

1. A system for generating a patient-specific drug safety and information bulletin, the system comprising:
an electronic data input and processing device including at least a display and means for inputting;
a medical record, specific to a particular patient, the record including at least a record of the patient's present medications;
a database accessible by the electronic data input and processing device, the database including elements, the elements further comprising;
a multiplicity of indications, the indications describing a medical or physiological condition in accordance with a standardized usage;
a multiplicity of normalized medication indices, each index linked to selected ones of the multiplicity of indications; and
a rule set, the rule set including definition of medication interactions;
an analysis application, hosted on the electronic data input and processing device, wherein particular ones of the interactions are automatically identified upon identification of a particular patient's medical record and input of a newly prescribed medication to the electronic data input and processing device; and
a drug safety and information bulletin template, the template including a first data portion which is automatically populated with the particular ones of the interactions specific to the particular patient.

2. The system according to claim 1, wherein the template includes a second data portion which is automatically populated with descriptive text relating to the newly prescribed medication.

3. The system according to claim 2, further comprising:
a multiplicity of textual strings, the strings including logical arguments disposed along the string; and
wherein the logical arguments each point to a database element, such that the database element is substituted for the logical argument in the textual string.

4. The system according to claim 3, wherein the respective text strings of the second data portion include logical arguments pointing to at least one database element selected from the group consisting of the prescription date, the medication name, the medication dose, the dose frequency, and the length of therapy.

5. The system according to claim 4, wherein the respective text strings of the first data portion include logical arguments pointing to at least one database element selected from the group consisting of medication-coexisting medication interactions, medication-coexisting disease interactions, medication-coexisting allergy interactions, contraindications, and precautions.

6. The system according to claim 5, wherein the populated template is human-readable and includes textual strings, including substituted database elements, characterized in patient-specific terms.

7. In an electronic medical records acquisition, retention and analysis program, a method for generating patient-specific drug safety instructions and information, the method comprising:
accessing a database for a medical record specific to the patient, the record including elements defining the patient's pre-existing medications, diseases, allergies, conditions and demographic status;
inputting a newly prescribed medication;
evaluating the newly prescribed medication against the patient's database elements;
identifying interactions between the newly prescribed medication and the patient's pre-existing medications, diseases, allergies, conditions and demographic status; and
generating patient-specific medication safety instructions literature including the identified interactions.

8. The method according to claim 7, the database further including medical knowledge elements, the medical knowledge elements comprising:
a multiplicity of indications, the indications describing a medical or physiological condition in accordance with a standardized usage;
a multiplicity of normalized medication indices, each index linked to selected ones of the multiplicity of indications; and
a rule set, the rule set including definition of interactions between other medical knowledge elements.

9. The method according to claim 8, wherein the patient-specific medication safety instructions are generated in accordance with a template, the template including a data portion which is automatically populated with the interactions specific to the particular patient.

10. The method according to claim 9, wherein the template includes a second data portion which is automatically populated with descriptive text relating to the newly prescribed medication.

11. The method according to claim 10, further comprising:
defining a multiplicity of textual strings, the strings including logical arguments disposed along the string;
associating each logical arguments to a database element; and
substituting the database element for the corresponding logical argument in the textual string.

12. The method according to claim 11, wherein the respective text strings of the second data portion include logical arguments pointing to at least one database element selected from the group consisting of the prescription date, the medication name, the medication dose, the dose frequency, and the length of therapy.

13. The method according to claim 12, wherein the respective text strings of the first data portion include logical arguments pointing to at least one database element selected from the group consisting of medication-coexisting medication interactions, medication-coexisting disease interactions, medication-coexisting allergy interactions, contraindications, and precautions.

14. A method for generating patient-specific medication safety instructions and information in a manner that takes not only a medication's identification, dose, and dose frequency into account, but also an entire spectrum of relevant clinical dimensions so as minimize the possibility of harmful interactions while simultaneously maximizing interaction information content, the method comprising:
establishing a dimensional indexing system implementing a database and performing therapeutic determinations by symbolic structural reasoning with respect to database elemental indices;
defining a template for receiving information text strings, the text strings including symbolic logic argument elements defined by the database elemental indices;
substituting layperson-intelligible terminology for symbolic logic argument elements in the text strings; and
populating the template with the substituted text strings.

15. The method according to claim 14 wherein the substituted text strings include symbolic logic argument elements pointing to at least one database element index selected from the group consisting of a prescription date, a medication name, a medication dose, a dose frequency, and a length of therapy.

16. The method according to claim 14, wherein the substituted text strings further include symbolic logic argument elements pointing to at least one database element index selected from the group consisting of a medication-coexisting medication interaction, a medication-coexisting disease interaction, a medication-coexisting allergy interaction, a contraindication, and a precaution.

17. The method according to claim 16, further comprising:
accessing a medical record specific to the patient, the record including database elemental indices defining the patient's pre-existing medications, diseases, allergies, conditions and demographic status;
evaluating a newly prescribed medication against the patient's database elemental indices; and
identifying interactions between the newly prescribed medication and the patient's pre-existing medications, diseases, allergies, conditions and demographic status.
